(19) United States
(12) Patent Application Publication
(10) Pub. No.: US 2024/0343595 A1
(43) Pub. Date: Oct. 17, 2024

(54) MULTIPRODUCT MANUFACTURING METHODS FOR PRUSSIAN BLUE ANALOGUES

(71) Applicant: Natron Energy, Inc., Santa Clara, CA (US)

(72) Inventors: Ashenafi Damtew Mamuye, Milpitas, CA (US); Daniel Friebel, San Carlos, CA (US); Aniruddh Shrivastava, San Jose, CA (US); Henry T. Ainley, San Jose, CA (US); Nicole J. Escorcia, San Jose, CA (US); Colin Deane Wessells, Menlo Park, CA (US)

(73) Assignee: Natron Energy, Inc., Santa Clara, CA (US)

(21) Appl. No.: 18/134,444

(22) Filed: Apr. 13, 2023

(51) Int. Cl. C01C 3/12; C25B 1/00

(52) U.S. Cl. CPC C01C 3/12; C25B 1/00; C01P 2002/72; C01P 2004/03

(57) ABSTRACT

A system and method for a multi-product manufacturing method capable of producing multiple different Prussian blue analogue electrochemically active coordination compounds for use in one or more conductive structures in such cells, for example, for use with a transition metal cyanide coordination compound (TMCCC) containing electrically-conductive structure (e.g., an electrode) as well as methods for use and manufacturing of such structures and electrochemical cells including these devices. One of a set of multiple different Prussian Blue analogue materials are capable of being prepared, directly or indirectly, from a common precursor mixture.

### FIELD OF THE INVENTION

The present invention relates generally to electrochemical cells including a multi-product manufacturing method capable of producing multiple different Prussian blue analogue electrochemically active coordination compounds for use in one or more conductive structures in such cells, and more specifically, but not exclusively, to an improvement in secondary sodium or potassium rich transition metal cyanide coordination compounds (TMCCC).

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Electrochemical cells play a critical role in energy storage in a variety of applications including, but not limited to, electric vehicles, grid storage applications, data center infrastructure, and consumer electronics. An important property of an electrochemical cell includes an ability to accumulate, hold, and release charge as needed. The application of an electrochemical cell is influenced by discharge rates at which the cell can be emptied without significant capacity loss and any change in operational characteristics of the cell by the accumulation, storage, and release of the charge.

The Li-ion battery has become a popular battery architecture for mobile applications such as electric vehicles and portable electronic devices in part because of the ability of a set of Li-ion batteries to provide high energy density without sacrificing performance and longevity. However, the increasing cost of Lithium as well as other essential components of the Li-ion battery have spurred advances into alternative, cheaper options for applications in which high energy density is not required.

Sodium is much more abundant than Lithium. In similar applications, and to an extent that a sodium-ion battery provides competitive performance as compared to a Li-ion battery, the sodium-ion architecture may serve as a suitable alternative to Lithium given the proper surrounding framework. Transmission metal cyanide coordination compounds (TMCCC) may be synthesized to create an open framework allowing for high mobility of Sodium ions through the lattice.

Within a category of sodium ion secondary batteries are classes that use Prussian blue analogue (PBA) compositions as an active material. There are different types of PBA materials and the current manufacturing systems for making multiple different classes of PBA materials are not always scalable, may use different, expensive, and special-order precursors. The processes may employ heating and pressurizing reaction conditions that may result in significant investments for constructing/reconfiguring/upgrading a manufacturing facility when the processes are tailored to one particular class/type of PBA.

Potassium/Sodium Prussian white can be made using autoclave, template synthesis and chelating agent with manufacturing process specific for one product.

Even with customized and adapted processes for each specific class of PBA, the process and equipment may result in batch-to-batch variance of poorly controlled particle size for production of corresponding TMCCC material.

There may be benefits to a multi-product manufacturing method capable of producing multiple different Prussian blue analogue electrochemically active coordination compounds for use in one or more conductive structures in such cells.

### BRIEF SUMMARY OF THE INVENTION

Disclosed is a system and method for a multi-product manufacturing method capable of producing multiple different Prussian blue analogue electrochemically active coordination compounds for use in one or more conductive structures in such cells, for example, for use with a transition metal cyanide coordination compound (TMCCC) containing electrically-conductive structure (e.g., an electrode) as well as methods for use and manufacturing of such structures and electrochemical cells including these devices. The following summary of the invention is provided to facilitate an understanding of some of the technical features related to a process architecture for multi-production production of PBAs, and is not intended to be a full description of the present invention. A full appreciation of the various aspects of the invention can be gained by taking the entire specification, claims, drawings, and abstract as a whole. The present invention is applicable to other electrochemically active compounds in addition to the specific compounds disclosed herein.

Embodiments of the present invention may include production capacity for a set of two or more different classes of TMCCC products (e.g., Na-PBA, Na-PWA, K-PBA, and K-PWA) using common starting materials in one over-arching simplified and compacted manufacturing process employing the same set of equipment, offering reduced expenses and time associated with reconfiguring manufacturing from one product of the set to another product of the set.

An electrochemical cell comprising an anode and a cathode electrode, the cathode electrode including a TMCCC represented by Formula I:

Na_{b1}K_{b2}R_{b3}Cs_{b4}Fr_{b5}Tiₐ₁Vₐ₂Crₐ₃Mnₐ₄Feₐ₅Coₐ₆Niₐ₇Cuₐ₈Znₐ₉Caₐ₁₀Mgₐ₁₁[R(CN)₆]_{c} vacᵣ n(H₂O)

FORMULA I; wherein R(CN)₆ includes a coordination complex selected from the group consisting of hexacyanoferrate, hexacyanocobaltate, hexacyanochromate, and hexacyanomanganate; wherein vac identifies an R(CN)₆ vacancy; wherein for at least one element of a set of alkali metal parameters {b1, b2}, {b1, b2} is >0 (Na or/and K is present); wherein for each element of the set {b1, b2, b3, b4, b5} excluding non-zero elements of the set of alkali metal parameters, 0≤{b1, b2, b3, b4, b5} (one of Na or K may be zero, as well as R, Cs, and Fr); wherein for each element of the set {b1, b2, b3, b4, b5}, {b1, b2, b3, b4, b5}≤2; wherein b1+b2+b3+b4+b5≤2; wherein for each element of the set {a1, a2, a3, a4, a5, a6, a7, a8, a9, a10, a11}, 0≤{a1, a2, a3, a4, a5, a6, a7, a8, a9, a10, a11}≤1; wherein at least two of {a1, a2, a3, a4, a5, a6, a7, a8, a9, a10, a11} are >0; wherein 0<c≤1; wherein 0≤r≤0.25; wherein c+r=1; and wherein n>0. In some embodiments, Feₐ₅ includes Fe(II)_{d1} and Fe(III)_{d2}, wherein d1+d2=a5, wherein 0≤d1≤1; and wherein 0≤d2≤1.

An embodiment may include a method for synthesizing one of a set of two or more Prussian blue analogue compositions (PBAC), each PBAC of the set of Prussian blue analogue compositions, including the steps of: (a) preparing a precursor mixture supporting each PBAC of the set of two or more Prussian blue analogue compositions; (b) selecting a particular one PBAC of the set of two or more Prussian blue analogue compositions; and thereafter; (c) producing the particular one PBAC using the precursor mixture.

An embodiment may include a method of producing a sodium based Prussian white analogue from a set of Fe(II) precursors using a kojic acid.

Advantages of some embodiments of the present invention may include one or more of: (a) providing multiple manufacturing processes that produce four different classes of materials in one manufacturing system; (b) using inexpensive and sulfur-containing reducing agents and readily available K salts for Na cation exchange; (c) employing a practical, inexpensive, and efficient method that can be scaled up at industrial scale; and (d) providing a batch-to-batch reproducibility of well controlled particle size production of corresponding TMCCC.

Any of the embodiments described herein may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a simplified and compacted manufacturing process capable of production of any of a set of Prussian blue analogue materials from common starting materials;

FIG. 2 illustrates a chart of x-ray diffraction (XRD) patterns of Example 2 (Na-PBA) and Example 5 (Na-PWA) TMCCC materials;

FIG. 3 illustrates a graph representing an electrochemical behavior of sodium based Prussian white (Example 1);

FIG. 4 illustrates a graph representing the electrochemical behavior of Potassium based Prussian white (Example 9);

FIG. 5 illustrates an SEM image depicting morphology and particle size of a powder product of Example 1;

FIG. 6 illustrates a chart of energy dispersive x-ray spectroscopy (EDX) of Example 10, confirming a completion of cation exchange; and

FIG. 7 illustrates a generic electrochemical cell.

### DETAILED DESCRIPTION OF THE INVENTION

Embodiments of the present invention may provide for a multi-product manufacturing method capable of producing multiple different Prussian blue analogue electrochemically active coordination compounds for use in one or more conductive structures in such cells, for example, for use with a TMCCC-containing electrically-conductive structure (e.g., an electrode) as well as methods for use and manufacturing of such structures and electrochemical cells including these devices. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

### Definitions

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The following definitions apply to some of the aspects described with respect to certain embodiments of the invention. These definitions may likewise be expanded upon herein.

As used herein, the term “or” includes “and/or” and the term “and/or” includes any and all combinations of one or more of the associated listed items. Expressions such as “at least one of,” when preceding a list of elements, modify the entire list of elements and do not modify the individual elements of the list.

As used herein, the singular terms “a,” “an,” and “the” include plural referents unless the context clearly dictates otherwise. Thus, for example, reference to an object can include multiple objects unless the context clearly dictates otherwise.

Also, as used in the description herein and throughout the claims that follow, the meaning of “in” includes “in” and “on” unless the context clearly dictates otherwise. It will be understood that when an element is referred to as being “on” another element, it can be directly on the other element or intervening elements may be present therebetween. In contrast, when an element is referred to as being “directly on” another element, there are no intervening elements present.

As used herein, the term “set” refers to a collection of one or more objects. Thus, for example, a set of objects can include a single object or multiple objects. Objects of a set also can be referred to as members of the set. Objects of a set can be the same or different. In some instances, objects of a set can share one or more common properties.

As used herein, the term “adjacent” refers to being near or adjoining. Adjacent objects can be spaced apart from one another or can be in actual or direct contact with one another. In some instances, adjacent objects can be coupled to one another or can be formed integrally with one another.

As used herein, the terms “connect,” “connected,” and “connecting” refer to a direct attachment or link. Connected objects have no or no substantial intermediary object or set of objects, as the context indicates.

As used herein, the terms “couple,” “coupled,” and “coupling” refer to an operational connection or linking. Coupled objects can be directly connected to one another or can be indirectly connected to one another, such as via an intermediary set of objects.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term is construed, absent a contrary value from context or explicit expression, as including a deviation of ±10 percent of the given numeric value provided such a deviation does not alter the end function or result of the value. Therefore, a value of about 1% may be construed to be a range from 0.9% to 1.1%.

As used herein, the terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

As used herein, the terms “optional” and “optionally” mean that the subsequently described event or circumstance may or may not occur and that the description includes instances where the event or circumstance occurs and instances in which it does not.

As used herein, the term “size” refers to a characteristic dimension of an object. Thus, for example, a size of an object that is spherical can refer to a diameter of the object. In the case of an object that is non-spherical, a size of the non-spherical object can refer to a diameter of a corresponding spherical object, where the corresponding spherical object exhibits or has a particular set of derivable or measurable properties that are substantially the same as those of the non-spherical object. Thus, for example, a size of a non-spherical object can refer to a diameter of a corresponding spherical object that exhibits light scattering or other properties that are substantially the same as those of the non-spherical object. Alternatively, or in conjunction, a size of a non-spherical object can refer to an average of various orthogonal dimensions of the object. Thus, for example, a size of an object that is a spheroidal can refer to an average of a major axis and a minor axis of the object. When referring to a set of objects as having a particular size, it is contemplated that the objects can have a distribution of sizes around the particular size. Thus, as used herein, a size of a set of objects can refer to a typical size of a distribution of sizes, such as an average size, a median size, or a peak size.

The TMCCC materials described herein may be used in an electrode in an electrochemical cell. The electrochemical cell may also include additional electrodes, an electrolyte and a separator membrane. Any additional electrodes may include a second TMCCC material, a carbon material such as activated charcoal, hard carbon, or graphite, or another material. The electrolyte may include one or more organic solvents such as acetonitrile, cyclic or linear carbonates, or other organic solvents, or water. The separator membrane may contain polymers and may have surface coating included but not limited to nano-alumina, and boehmite.

As used herein, the term “electrode” in the context of an electrochemical cell may have different meanings and sometimes encompass different sets of components of the electrochemical cell in different contexts and different audiences. For example, the electrode, as comprised by the TMCCC, carbon, and binder, as well as the solvents used in the slurry processing to make the electrode, is typically considered to be entirely separate from a current collector. This electrode structure could be deposited on any number of current collectors having different compositions (aluminum, copper, etc.) or mechanical properties (thickness, surface roughness, and the like). One precise definition would be to refer to an “electrode” as comprising two components: both an “active layer” or “electrode composite” including the TMCCC, carbons, and binders, as well as a current collector, which may in turn have subcomponents such as a special surface coating, or special design features such as physical dimensions. The present application has adopted a special term used herein to avoid some imprecision that is present when referring to an electrode of an electrochemical cell. This term is “electrically conductive structure” and includes electrodes as well as other electrochemically-active structures that may be used as an electrode. Some larger structures that encompass an electrode may also be such an “electrically conductive structure” within the meaning of the present application, unless the context would reasonably suggest otherwise to a person having ordinary skill in the art apprised of this disclosure and understanding of the discussion and claims presented herein.

Embodiments of the present invention generally relates to electrochemical cells and, more particularly, to a method for synthesizing sodium- or potassium-rich Fe-substituted Mn-based TMCCC of the general formula AₓPₘP′_{y}P″ₖ[R(CN)₆]_{z} (Vac)ᵣ·nH₂O, for example, for use in battery electrodes. Wherein A represents at least one alkali metal and A includes Na or K or a combination of Na and K; P. P′ and P″ include a transition metal from the group consisting of iron (Fe), manganese (Mn), zinc (Zn), nickel (Ni), copper (Cu) or chromium (Cr); R(CN)₆ include a coordination complex from the group consisting of hexacyanoferrate, hexacyanocobaltate, hexacyanochromate, hexacyanomanganate wherein 0<x≤2, 0≤m≤1, 0<y≤1, 0<k≤1, 0<z≤1, 0≤r≤0.25, 0<n, and (Vac) identifies an R(CN)₆ vacancy, where z+r=1. Specific embodiments may include one or more materials conforming to Formula I herein.

An embodiment of the present invention may include one or more compositions conforming to Formula I:

Na_{b1}K_{b2}R_{b3}Cs_{b4}Fr_{b5}Tiₐ₁Vₐ₂Crₐ₃Mnₐ₄Feₐ₅Coₐ₆Niₐ₇Cuₐ₈Znₐ₉Caₐ₁₀Mgₐ₁₁[R(CN)₆]_{c} vacᵣ n(H₂O)

FORMULA I; wherein R(CN)₆ includes a coordination complex selected from the group consisting of hexacyanoferrate, hexacyanocobaltate, hexacyanochromate, and hexacyanomanganate; wherein vac identifies an R(CN)₆ vacancy; wherein for at least one element of a set of alkali metal parameters {b1, b2}, {b1, b2} is >0 (Na or/and K is present); wherein for each element of the set {b1, b2, b3, b4, b5} excluding non-zero elements of the set of alkali metal parameters, 0≤{b1, b2, b3, b4, b5} (one of Na or K may be zero, as well as R, Cs, and Fr); wherein for each element of the set {b1, b2, b3, b4, b5}, {b1, b2, b3, b4, b5}≤2; wherein b1+b2+b3+b4+b5≤2; wherein for each element of the set {a1, a2, a3, a4, a5, a6, a7, a8, a9, a10, a11}, 0≤{a1, a2, a3, a4, a5, a6, a7, a8, a9, a10, a11}≤1; wherein at least two of {a1, a2, a3, a4, a5, a6, a7, a8, a9, a10, a11} are >0; wherein 0<c≤1; wherein 0≤r≤0.25; wherein c+r=1; and wherein n>0. In some embodiments, Feₐ₅ includes Fe(II)_{d1} and Fe(III)_{d2}, wherein d1+d2=a5, wherein 0≤d1≤1; and wherein 0≤d2≤1.

In Formula I, wherein the phrase “for at least one element of a set of alkali metal parameters {b1, b2}, {b1, b2} is >0” means that one or both of b1 and b2 is greater than zero.

In Formula I, wherein the phrase “wherein for each element of the set {b1, b2, b3, b4, b5} excluding non-zero elements of the set of alkali metal parameters, 0≤{b1, b2, b3, b4, b5}” means that, except for the set of alkali metal parameters (b1 and b2) that are greater than zero, any of the other parameters b1, b2, b3, b4, and b5 is greater than or equal to zero.

In Formula I, wherein the phrase “wherein for each element of the set {b1, b2, b3, b4, b5}, {b1, b2, b3, b4, b5}≤2” means that none of b1, b2, b3, b4, or b5 is greater than 2.

In Formula I, wherein the phrase “wherein for each element of the set {a1, a2, a3, a4, a5, a6, a7, a8, a9, a10, a11}, 0≤{a1, a2, a3, a4, a5, a6, a7, a8, a9, a10, a11}≤1” means that each element of the set is greater than or equal to zero and less than or equal to one.

In Formula I, wherein the phrase “wherein at least two of {a1, a2, a3, a4, a5, a6, a7, a8, a9, a10, a11} are >0” means that two or more of a1, a2, a3, a4, a5, a6, a7, a8, a9, a10, and a11 are greater than zero.

A cathode material is generally prepared by addition of a mixed solution of Fe(iii) and another metal ion to an aqueous ferrocyanide solution. The reaction could also be performed by co-precipitation method where the particle morphology is adjusted by addition time, stirring speed, concentration and temperature to result in TMCCC.

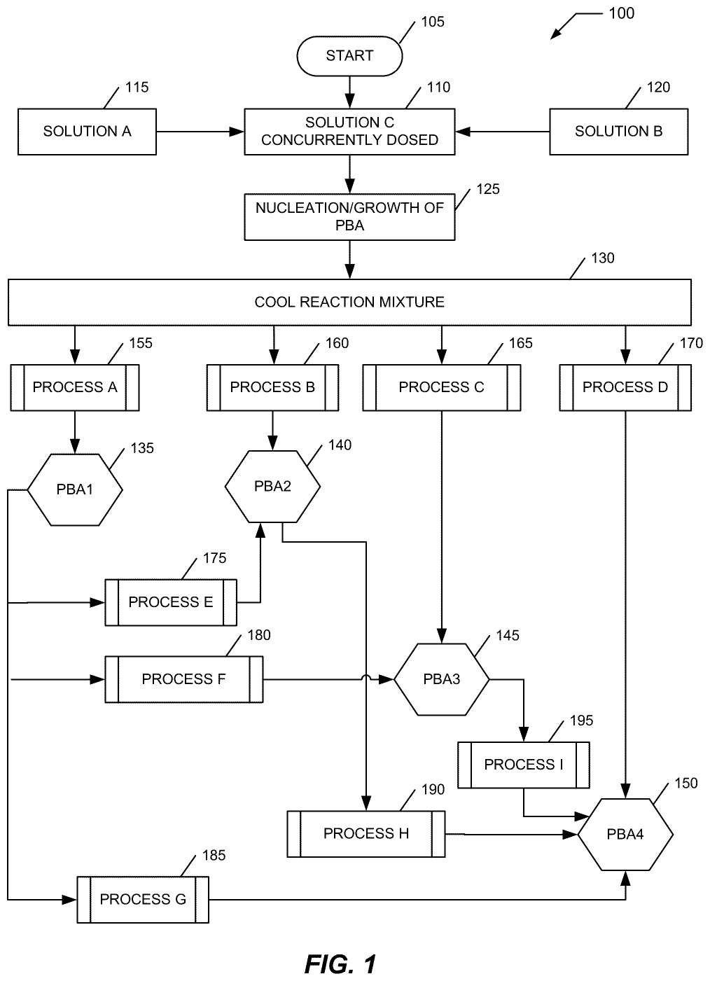

FIG. 1 illustrates a simplified and compacted manufacturing process 100 capable of production of any of a set of Prussian blue analogue materials from common starting materials, the PBA materials of the set related by redox reagents, ion exchange with isolation of one or more materials—one or more members of the set capable of being used as a precursor material for one or more other members of the set. For purposes of simplifying disclosure of the present invention, the set includes four Prussian blue analogue materials: (a) sodium based Prussian blue analogue (Na-PBA), (b) potassium based Prussian blue analogue (P-PBA), (c) sodium based Prussian white analogue (Na-PWA); (d) potassium based Prussian white analogue (K-PWA). The specific redox reagents, ion exchanges, and isolations are based upon the specific members of the set.

Process 100 includes several steps in parallel or serial as further described below. Process 100 includes a start step 105 wherein reagents and solutions are prepared and made available. After start step 105, process 100 includes a step 110 producing a solution C from a concurrent dosing of a solution A (from a step 115) with a solution B (from a step 120). Solution A includes a mixed aqueous solution of Fe(iii) and Mn(ii) ions and Solution B includes an aqueous solution of ferrocyanide, and Solution C becomes a mixed aqueous solution of Fe(iii), Mn(ii), and sodium salt at a temperature between 20-98° C., the specific temperature may vary depending on whether the PBA of the set is being directly or indirectly produced. For example, indirect production of PBA2 (e.g., Na-PWA), the mixture from step 110 and nucleation of step 125 may be performed at 80° C.

After step 110, process 100 includes a step 125 includes nucleation and growth of a reaction mixture having a Prussian blue analogue within the same temperature range: between 20-98° C.

After step 125, process 100 includes a step 130 wherein the reaction mixture of step 125 is cooled producing a cooled reaction mixture. Process 100 is configured to enable any of the set of PBA materials to be produced from the cooled reaction mixture using the same equipment. For this example, process 100 may directly produce a PBA1 (for example Na-PBA at a step 135), a PBA2 (for example Na-PWA at a step 140), a PBA3 (for example K-PBA at a step 145), and a PBA4 (for example K-PWA at a step 150).

Further, one of the directly produced PWA materials may be used as a precursor material for indirect production of another of PBA of the set of PWA from the cooled reaction mixture from step 130.

For production of PBA1, process 100 includes a step 155 that applies a process A to the cooled reaction mixture from step 130. For the specific example wherein PBA1 includes Na-PBA, process A of step 155 includes an isolation of Na-PBA from the cooled reaction mixture of step 130. Isolation may include a process involving filtration/centrifugation and washing of a precipitate with a solvent and then drying under vacuum.

For production of PBA2, process 100 includes a step 160 that applies a process B to the cooled reaction mixture from step 130. For the specific example wherein PBA2 includes Na-PWA, process B of step 160 includes an application of a reducing agent A to the cooled mixture from step 130 and then an isolation. In this specific example, reducing agent A includes a mixture of sulfur containing reducing agent, succinic acid and sodium hydroxide.

For production of PBA3, process 100 includes a step 165 that applies a process C to the cooled reaction mixture from step 130. For the specific example wherein PBA3 includes K-PBA. process C of step 165 includes a cation exchange with the cooled mixture from step 130 and then an isolation. In this specific example, the cation exchange includes a process involving sodium ion exchange with potassium ion, using a potassium salt.

For production of PBA4, process 100 includes a step 170 that applies a process D to the cooled reaction mixture from step 130. For the specific example wherein PBA4 includes K-PWA, process D of step 170 includes an application of a reducing agent B to the cooled mixture from step 130 and then an isolation. In this specific example, reducing agent B includes a mixture of sulfur containing reducing agent, succinic acid, potassium hydroxide and potassium sulfate.

Versatility and flexibility of process 100 is further evidenced by indirect production of one of PBA2, PBA3, or PBA4 from PBA1 of step 135 in addition to the possibility of direct production as discussed above.

For production of PBA2 from PBA1, process 100 includes a step 175 that applies a process E to PBA1. For the present example where PBA1 includes Na-PBA and PBA2 includes Na-PWA, process E includes application of the reducing agent A to Na-PBA of step 135 followed by an isolation.

For production of PBA3 from PBA1, process 100 includes a step 180 that applies a process F to PBA1. For the present example where PBA1 includes Na-PBA and PBA3 includes K-PBA, process F includes application of the cation exchange to Na-PBA of step 135 followed by an isolation.

For production of PBA4 from PBA1, process 100 includes a step 185 that applies a process G to PBA1. For the present example where PBA1 includes Na-PBA and PBA4 includes K-PWA, process G includes application of the reducing agent B to Na-PBA of step 135 followed by an isolation.

For production of PBA4 from PBA2, process 100 includes a step 190 that applies a process H to PBA2. For the present example where PBA2 includes Na-PWA and PBA4 includes K-PWA, process H includes application of cation exchange to Na-PWA of step 140 followed by an isolation.

For production of PBA4 from PBA3, process 100 includes a step 195 that applies a process I to PBA3. For the present example, where PBA3 includes K-PBA and PBA4 includes K-PWA, process I includes application of a reducing agent C followed by an isolation. In this specific example, reducing agent C includes a sodium free sulfur containing reducing agent.

The corresponding sodium/potassium-rich Prussian white compound produced by process 100 delivers a higher reversible capacity than Prussian blue. The reduction of Prussian blue to Prussian white involves a reduction of Fe(iii) to Fe(ii) along with sodium or potassium ion insertion. The reduction of Fe(iii) to Fe(ii) in TMCCC with an inexpensive reducing agent facilitates the commercialization of Na-ion and K-ion batteries.

Alternatively, process 100 may synthesis Na-PWA directly from Fe(II) starting material using hydroxy ketones such as kojic acid as chelating agent.

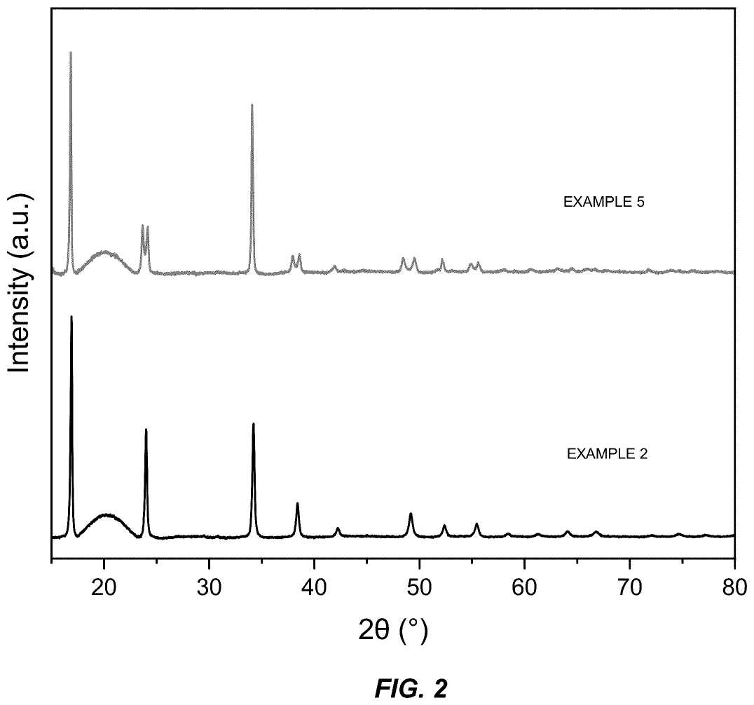

In addition, described herein is a synthesis method in which a novel class of sulfur-containing reducing agents is used to produce TMCCC with high sodium or potassium content for electrochemical energy storage devices. While previous reports, for example REF[1] and REF[2], may have suggested using sodium dithionite for Prussian blue reduction, they have been limited to Fc₄[Fc(CN)₆]₃ for small scale analytical applications, with some requiring the use of acidic media. Attempts to apply the aforementioned methods to the production of sodium- and potassium-rich TMCCC electrode materials for secondary battery applications gave highly unsatisfactory results. The TMCCC materials underwent degrading side reactions with the dithionite reaction mixture, and a significant decrease of the reaction mixture's pH during reaction was observed, which destabilizes both the TMCCC material as well as the reducing agent itself, leading to hazardous release of hydrogen cyanide and of sulfur dioxide. The process innovation described herein performs buffer based controlled reduction of TMCCC having a predominantly monoclinic structure (See, FIG. 2—FIG. 2 illustrates a chart of x-ray diffraction (XRD) patterns of Example 2 (Na-PBA) and Example 5 (Na-PWA) TMCCC materials) or TMCCC cathode materials having three different oxidation-reduction potentials for nitrogen-coordinated Fe^{2+/3+}, carbon-coordinated Fe^{2+/3+}, and nitrogen-coordinated Mn^{2+/3+}. Furthermore, the cation exchange and/or the reduction process is demonstrated at large scale. An advantage of these combinations is that a particle size distribution can be optimized through the parameters of one precipitation reaction leading to a first Na-containing TMCCC material, and said Na-containing TMCCC material can then be converted into a variety of compositions that have higher sodium content or that contain a high potassium content instead of sodium, while retaining the particle size distribution of the first Na-containing TMCCC material as a template. This is an enormous advantage because the optimization of particle size in TMCCC materials requires lengthy process development efforts and certain combinations of composition and particle size, without said template approach, can only be achieved through the use of additives such as chelating agents, or through lower concentrations of precursor salts, and these modifications lead to permanently increased manufacturing costs for TMCCC materials. Further, this reduction process can be used to control an initial state of charge of TMCCC cathodes for the use in sodium/potassium ion batteries, which has never been demonstrated in previous works.

Numerous attempts to reduce TMCCC materials with a mixed composition containing Fe(III) and Mn(II) with hydrazine sulfate, forming gas, sodium borohydride, ascorbic acid, sodium thiosulphate and sodium hypophosphite failed to produce the corresponding Prussian white.

As such some embodiments of the present invention relate to a simple and cost-effective method of synthesis of Na-PBA, Na-PWA, K-PBA, and K-PWA by using sulfur-containing reducing agents and potassium salt for cation exchange to produce in large scale high quality TMCCC materials.

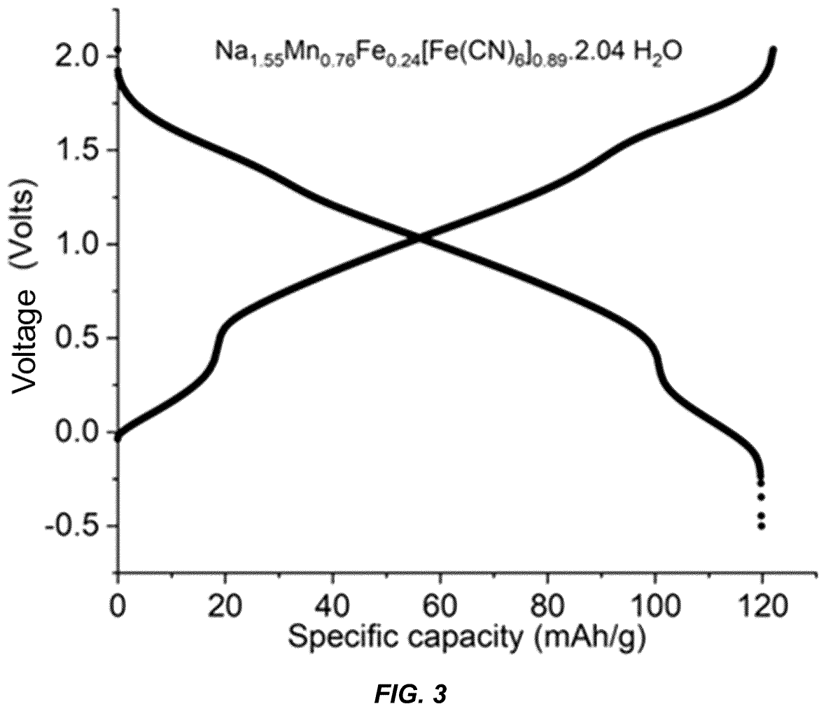

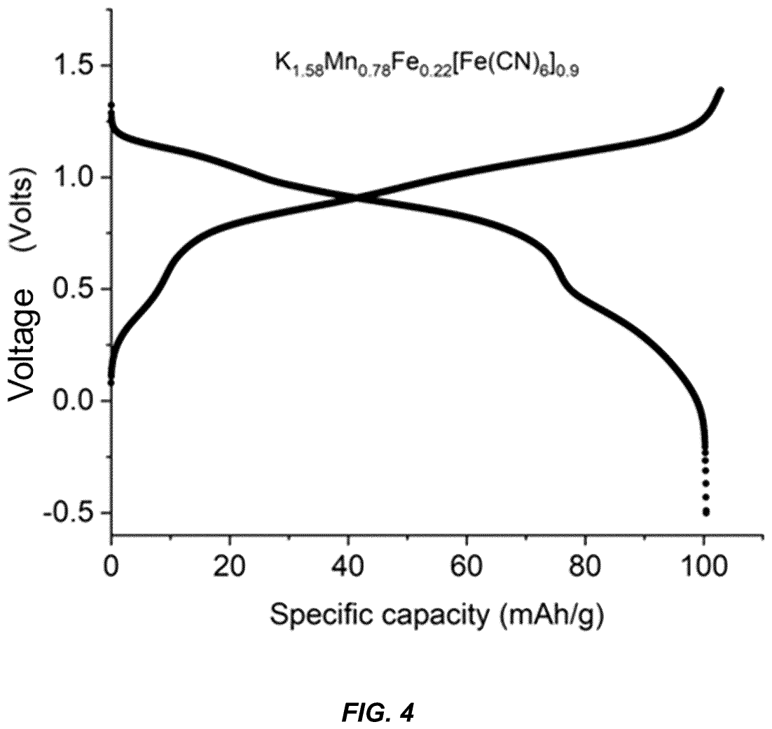

In addition to process 100 preparation (direct or indirect) of one of four different TMCCC materials, the disclosure demonstrates its application in a sodium-ion battery and potassium-ion battery. FIG. 3 illustrates a graph representing an electrochemical behavior of sodium based Prussian white (Example 1 below) and FIG. 4 illustrates a graph representing the electrochemical behavior of Potassium based Prussian white (Example 9 below).

The examples below illustrate an importance of these physical morphology criteria disclosed as part of embodiments of the present invention.

### EXPERIMENTAL SECTION

### Example 1: Sodium Based Prussian White Analogue (Na-PWA)

In a 1 L jacketed reactor equipped with a mechanical stirrer, water (209.25 g) and sodium sulfate (2.08 g) were added, and the resulting solution is stirred at 400 r.p.m. at 80° C.

To this mixture, a homogenous solution of iron(III) sulfate hydrate (20.09 g) and manganese(II) sulfate monohydrate (45.17 g) in water (154.93 g) and a homogenous solution of sodium hexacyanoferrate(II) decahydrate (131.14 g) and potassium hexacyanoferrate(III) (0.13 g) in water (399.9 g) were simultaneously added dropwise over a period of 120 minutes. Once the addition was completed, the resulting mixture was stirred for another 60 minutes and then cooled to room temperature.

Then the mixture was purged for 20 minutes using N2 gas to keep the reaction mixture under inert atmosphere.

To this mixture a buffer solution made from succinic acid (29 g) and sodium hydroxide (9 g) in water (50 g) was added and mixed for 5 minutes. Then sodium dithionite (94 g) was added. The reaction mixture was stirred for additional 15 minutes to complete the sodiation.

Finally, under inert atmosphere the reaction mixture was filtered, and the powder was washed with water (1×150 g, 1×368 g) and then with methanol (143 g) to yield a white powder. This powder was then dried under reduced pressure at 80° C. for 18 h.

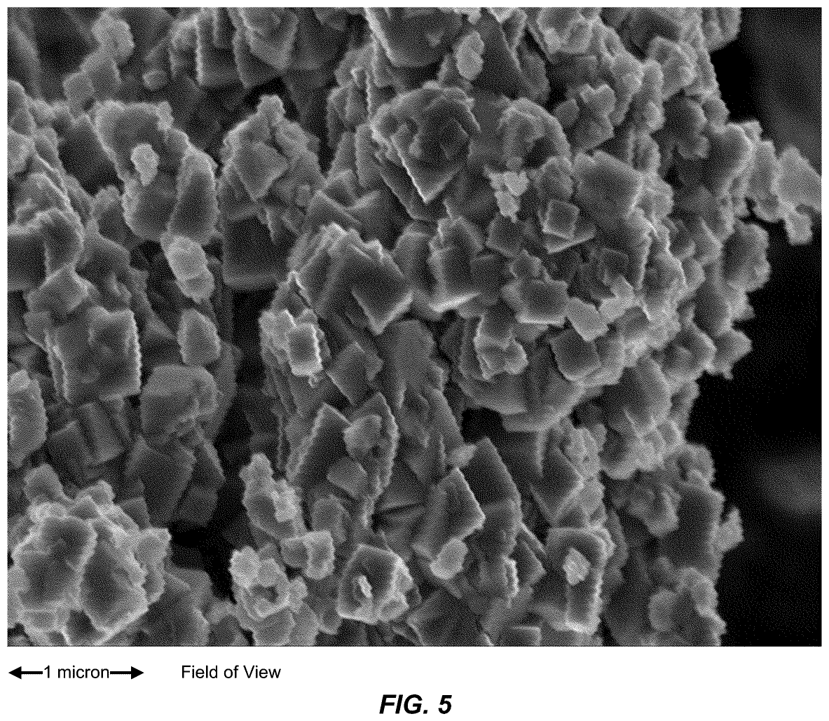

The morphology and size of these particles were confirmed by scanning electron microscopy (SEM) in FIG. 5 (FIG. 5 illustrates an SEM image depicting morphology and particle size of a powder product of Example 1)

### Example 2: Sodium Based Prussian Blue Analogue (Na-PBA)

A jacketed reactor equipped with a mechanical stirrer was charged with water (263.4 kg) and sodium sulfate (2.6 kg), and the resulting solution was stirred at 400 rpm at 80° C.

To this mixture, a homogenous solution of iron(III) sulfate hydrate (16.46 kg) and manganese(II) sulfate monohydrate (53.5 kg) in water (140 kg) and a homogenous solution of sodium hexacyanoferrate(II) decahydrate (149.5 kg) and potassium hexacyanoferrate(III) (0.144 kg) in water (465.5 kg) were simultaneously added dropwise over a period of 120 minutes. Once the addition was completed, the resulting mixture was stirred for another 60 minutes and then cooled to room temperature.

Then the precipitate was separated by centrifugation in two centrifuge loads. Each load was washed by 1×60 gallons water, 1×123 gallons water and 2×90 kg isopropanol. This powder was then dried under reduced pressure at 80° C. for 18 h.

### Example 3: Sodium Based Prussian White Analogue (Na-PWA)

Under inert atmosphere, the dried Prussian blue powder of Example 2 (20 g) was charged to a 2 L reactor containing succinic acid (7.5 g) and water (1000 g). The mixture was stirred for 5 minutes, and then sodium dithionite (31 g) was added. The mixture was stirred for 15 minutes to complete sodiation. Then the reaction mixture was filtered, and the powder was washed with water (1×150 g) and then with methanol (150 g) to yield a white powder. This powder was then dried under reduced pressure at 80° C. for 18 h.

### Example 4: Sodium Based Prussian White Analogue (Na-PWA)

Under inert atmosphere, the dried Prussian blue powder of Example 2 (20 g) was added to a 1 L reactor containing succinic acid (5.8 g), sodium hydroxide (1.8 g) and water (100 g). Then the mixture was stirred for 5 minutes and sodium dithionite (18.8 g) was added. The mixture was stirred for 15 minutes to complete sodiation. The reaction mixture was filtered, and the powder was washed with water (1×27 g) and then with methanol (12 g) to yield a white powder. This powder was then dried under reduced pressure at 80° C. for 18 h.

### Example 5: Sodium Based Prussian White Analogue (Na-PWA)

The same as Example 4, except that the reaction was scaled up 37.5 times and the Prussian white powder dried for 24 hours instead of 18 hours.

### Example 6: Sodium Based Prussian White Analogue (Na-PWA)

Under inert atmosphere, the dried Prussian blue powder of Example 2 (20 g) was added to a 1 L reactor containing succinic acid (7.5 g), zinc sulfate (2 g) and water (100 g). Then the mixture was stirred for 5 minutes and sodium dithionite (31 g) was added. The mixture was stirred for 15 minutes to complete sodiation. Then the reaction mixture was filtered, and the powder was washed with water (1×150 g) and then with methanol (150 g) to yield a white powder. This powder was then dried under reduced pressure at 80° C. for 18 h.

### Example 7: Sodium Based Prussian White Analogue (Na-PWA)

Under inert atmosphere, the dried Prussian blue powder of Example 2 (40 g) was added to a 2 L reactor containing succinic acid (15 g) and water (1000 g). Then the mixture was stirred for 5 minutes and 21.15 g of Rongolite (sodium hydroxymethanesulfinate) was added. The mixture was heated to 50° C. and stirred for 15 minutes to complete sodiation. Then the reaction mixture was cooled to room temperature, filtered, and the powder was washed with water (1×160 g) and then with methanol (64 g) to yield a white powder. This powder was then dried under reduced pressure at 80° C. for 18 h.

### Example 8: Sodium Based Prussian White Analogue (Na-PWA)

Under inert atmosphere, the dried Prussian blue powder of Example 2 (40 g) was added to a 2 L reactor containing succinic acid (15 g), sodium sulfate (16.96 g) and water (1000 g). Then the mixture was stirred for 5 minutes and 19.36 g of thiourea dioxide was added. The mixture was heated to 80° C. and stirred for 5 minutes to complete sodiation. Then the reaction mixture was cooled to room temperature, filtered, and the powder was washed with water (1×160 g) and then with methanol (64 g) to yield a white powder. This powder was then dried under reduced pressure at 80° C. for 18 h.

### Example 9: Potassium Based Prussian White Analogue (K-PWA)

Under inert atmosphere, the dried Prussian blue powder of Example 2 (40 g) and potassium sulfate (30 g) were added to a 1 L reactor containing succinic acid (5.8 g), potassium hydroxide (2.4 g) and water (400 g). Then the mixture was stirred for 5 minutes, and sodium dithionite (38 g) was added. The mixture was stirred for an additional 15 minutes. The reaction mixture was filtered, and the powder was washed with water (1×80 g) and then with methanol (32 mL) to yield a light blue powder. This powder was then dried under reduced pressure at 80° C. for 18 h.

### Example 10: Potassium Based Prussian White Analogue (K-PWA)

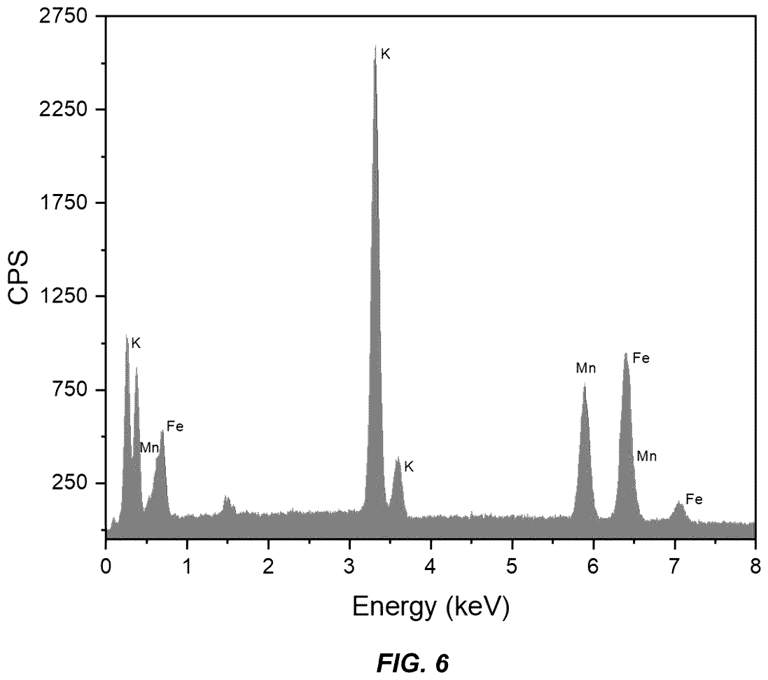

Under inert atmosphere, the dried Prussian blue powder of Example 2 (20 g) was added to a 2 L reactor containing succinic acid (7.5 g) and water (1000 g). The mixture was stirred for 5 minutes, and sodium dithionite (31 g) was added. The mixture was stirred for 15 minutes to complete sodiation. The reaction mixture was filtered, and the powder was washed with water (50 g) and then cake was re-slurried in a solution of potassium acetate (11.71 g), methanol (100 g) and water (100 g) and stirred for 60 minutes to complete Na-K ion exchange (See FIG. 6 which illustrates a chart of energy dispersive x-ray spectroscopy (EDX) of Example 10, confirming a completion of cation exchange). Then reaction mixture was filtered, and the powder was washed with water (50 mL) and then with methanol (50 mL) to yield a light blue powder. This powder was then dried under reduced pressure at 80° C. for 18 h.

### Example 11: Potassium Based Prussian White Analogue (K-PWA)

Under inert atmosphere, the dried Prussian blue powder of Example 2 (40 g) was added to a 2 L reactor containing succinic acid (15 g), potassium acetate (23.43 g) and water (1000 g). After the mixture was stirred for 5 minutes, 19.36 g of thiourea dioxide was added. The mixture was heated to 70° C. and stirred for 5 minutes to complete potassium insertion process.

Then the reaction mixture was cooled to room temperature, filtered, and the powder was washed with water (160 mL) and then with methanol (64 mL) to yield a white powder. This powder was then dried under reduced pressure at 80° C. for 18 h.

### Example 12: Sodium Based Prussian White Analogue (Na-PWA)

In a 1 L jacketed reactor equipped with a mechanical stirrer, water (171.5 g) and sodium sulfate (1.72 g) were added, and the resulting solution is stirred at 200 r.p.m at 80° C. under N2 atmosphere. Then 2% sulfate solution was added over a minute. To control particle morphology, seeding was achieved by simultaneous addition of “hexacyanoferrate” solution (1.53 mL) and “sulfate solution” (0.53 mL) over 0.5 minutes.

To this mixture, the remaining “hexacyanoferrate” solution and “sulfate solution” are simultaneously added dropwise over a period of 120 minutes. Once the addition completed, the resulting mixture was stirred for another 60 minutes and then cooled to room temperature.

The reaction mixture was filtered, and the powder was washed with water (1×150 g) and then with methanol (80 g) to yield a light blue powder. This powder was then dried under reduced pressure at 80°° C. for 18 h.

### Note:

“sulfate” solution preparation: Under inert atmosphere, a mixture of iron(II) sulfate heptahydrate (21.06 g) and manganese(II) sulfate monohydrate (34.88 g), Kojic acid (3 g) and water (115 g) were stirred for 240 minutes.

“hexacyanoferrate” solution preparation: under inert atmosphere, a mixture of sodium hexacyanoferrate(II) decahydrate (97.5 g), potassium hexacyanoferrate(III) (0.094 g) and water (303.6 g) were stirred for 60 minutes.

### Example 13: Sodium Based Prussian White Analogue (Na-PWA)

A 1 L jacketed reactor equipped with a mechanical stirrer was charged with water (171.5 g), ascorbic acid (6.5 g), anhydrous sodium sulfate (1.72 g) and ethylene glycol (121.5 g), and the resulting solution was stirred at 200 r.p.m at 65° C. under N2 atmosphere. Then 2% of the sulfate precursor solution was added over one minute.

To control particle morphology, seeding was achieved by simultaneous addition of “hexacyanoferrate” solution (1.50 mL) and “sulfate solution” (0.52 mL) over 0.5 minutes.

To this mixture, the remaining “hexacyanoferrate” solution and “sulfate solution” were simultaneously added dropwise over a period of 120 minutes. The solution was then aged for 1 hour, and subsequently filtered and washed with water (1×150 g) and methanol (80 g). The isolated material was dried at 80° C. under vacuum in inert atmosphere for 18 hours and a white powder with a very light blue tint was obtained.

“sulfate” solution preparation: Under inert atmosphere, a mixture of iron(II) sulfate heptahydrate (21.06 g) and manganese(II) sulfate monohydrate (34.88 g) and water (115 g) were stirred for 240 minutes.

“hexacyanoferrate” solution preparation: under inert atmosphere, a mixture of sodium hexacyanoferrate(II) decahydrate (97.5 g), potassium hexacyanoferrate(III) (0.094 g) and water (303.6 g) were stirred for 60 minutes.

### Example 14: Sodium Based Prussian Blue Analogue (Na-PBA)

To a stirred solution of sodium sulfate (2.60 g) in water (253 mL), an initial 2 wt % of a solution of ferric sulfate (55 g) and manganese sulfate (171.2 g) in water (508.5 mL) were added. The remaining sulfate solution and a solution of sodium ferrocyanide (230.3 g) and potassium ferricyanide (0.216 g) in water (716.9 mL) that was treated with 0.200 g of A-15 resin to adjust its pH to 10, were added at constant rate over 120 min at 83° C. with a stirrer speed of 200 rpm. The solution was then aged for 1 hour, and subsequently filtered and washed with water (400 g) and methanol (200 g). The isolated material was dried at 80° C. under vacuum for 16 hours.

### Example 15: Sodium Based Prussian Blue Analogue (Na-PBA)

To a stirred solution of sodium sulfate (5.20 g) in water (526.8 mL), 2 wt % of a solution of ferric sulfate (57.5 g) and manganese sulfate (137.2 g) in water (460.2 g) were added. The remaining solution and a solution of sodium ferrocyanide (336.4 g), and potassium ferricyanide (0.320 g) in water (1047.4 g), which was treated with A-15 resin to reach a pH of 7, were added at constant rate over 120 min at 83° C. The solution was then aged for 1 hour, filtered and washed with water (378 g) and methanol (360 g). The isolated material was dried at 80° C. under vacuum for 7 hours.

### Example 16: Sodium Based Prussian Blue Analogue (Na-PBA)

To a stirred solution of sodium sulfate (2.6 g) in water (253 mL), an initial 2 wt % of a solution of ferric sulfate (64.5 g), manganese sulfate (171.2 g) in water (508.5 g) were added. The remaining sulfate solution and a solution of sodium ferrocyanide (230.2 g) and potassium ferricyanide (0.215 g) in water (716.9 mL), which was treated with 0.540 g of A-15 resin, were added at constant rate over 120 min at 83° C. with a stirrer speed of 200 rpm. The solution was then aged for 1 hour. After cooling to room temperature, the reaction solution was then treated with 1M NaHCO3 until a pH of 6 was achieved. Subsequently, the solution was filtered and washed with water (189 g) and isopropyl alcohol (180 g). The isolated material was dried at 80° C. under vacuum for 16 hours.

### Example 17: Sodium Based Prussian Blue Analogue (Na-PBA)

To a stirred solution of sodium sulfate (5.20 g) in water (526.8 mL), 2 wt % of a solution of ferric sulfate (57.5 g) and manganese sulfate (152.4 g) in water (460.2 g) were added. The remaining solution and a solution of sodium ferrocyanide (336.4 g), and potassium ferricyanide (0.320 g) in water (1047.4 g), which was treated with 0.05M H2SO4 to reach a pH of 7, were added at constant rate over 120 min at 83° C. with a stirrer speed of 200 rpm. The solution was then aged for 1 hour, filtered and washed with water (378 g) and methanol (360 g). The isolated material was dried at 80° C. under vacuum for 7 hours.

### Example 18: Sodium Based Prussian Blue Analogue (Na-PBA)

To a stirred solution of sodium sulfate (5.20 g) in water (526.8 mL), 2 wt % of a solution of ferric sulfate (56.7g) and manganese sulfate (140 g) in water (460.2 g) were added. The remaining solution and a solution of Sodium ferrocyanide (336.4 g), and potassium ferricyanide (0.320 g) in water (1047.4 g), which was treated with A-15 resin to reach a pH of 7, were added at constant rate over 30 min at 83° C. with a stirrer speed of 400 rpm. The solution was then aged for 1 hour, and the remainder of the solutions was added at constant rate for 90 minutes. The resulting solution was then filtered and washed with water (378 g) and methanol (360 g). The isolated material was dried at 80° C. under vacuum for 7 hours.

### Example 19: Sodium Based Prussian Blue Analogue (Na-PBA)

To a stirred solution of sodium sulfate (5.20 g) in water (526.8 mL), 2 wt % of a solution of ferric sulfate (56.7 g) and manganese sulfate (140 g) in water (460.2 g) were added. The remaining solution and a solution of sodium ferrocyanide (336.4 g), and potassium ferricyanide (0.320 g) in water (1047.4 g), which was treated with A-15 resin to reach a pH of 7, were added at constant rate over 10 min at 83° C. with a stirrer speed of 400 rpm. The solution was then aged for 1 hour, and the remainder of the solutions was added at constant rate for 110 minutes. The resulting solution was then filtered and washed with water (378 g) and methanol (360 g). The isolated material was dried at 80° C. under vacuum for 7 hours.

### Example 20: Sodium Based Prussian Blue Analogue (Na-PBA)

To a stirred solution of sodium sulfate (5.20 g) in water (526.8 mL), 2 wt % of a solution of ferric sulfate (56.7 g) and manganese sulfate (140 g) in water (460.2 g) were added. The remaining solution and a solution of sodium ferrocyanide (336.4 g), and potassium ferricyanide (0.320 g) in water (1047.4 g), which was treated with A-15 resin to reach a pH of 7, were added at constant rate over 60 min at 83°° C. with a stirrer speed of 400 rpm. The solution was then aged for 1 hour, and the remainder of the solutions was added at constant rate for 60 minutes. The resulting solution was then filtered and washed with water (378 g) and methanol (360 g). The isolated material was dried at 80° C. under vacuum for 7 hours.

Table 1 summarizes a set of elemental compositions of the noted example TMCCC materials.

TABLE 1

| Example | Na | Mn | Fe (II) | Fe (III) | Fe(CN)₆ | Vac | Water |
|---|---|---|---|---|---|---|---|
| 1 | 1.55 | 0.76 | 0.24 | 0 | 0.89 | 0.11 | 2.04 |
| 2 | 1.17 | 0.76 | 0 | 0.24 | 0.85 | 0.15 | 4.06 |
| 3 | 1.57 | 0.79 | 0.21 | 0 | 0.89 | 0.11 | 1.68 |
| 4 | 1.53 | 0.79 | 0.21 | 0 | 0.88 | 0.12 | 1.65 |
| 5 | 1.54 | 0.79 | 0.21 | 0 | 0.89 | 0.11 | 1.88 |
| 13 | 1.53 | 0.70 | 0.24 | 0.06 | 0.90 | 0.10 | 1.70 |

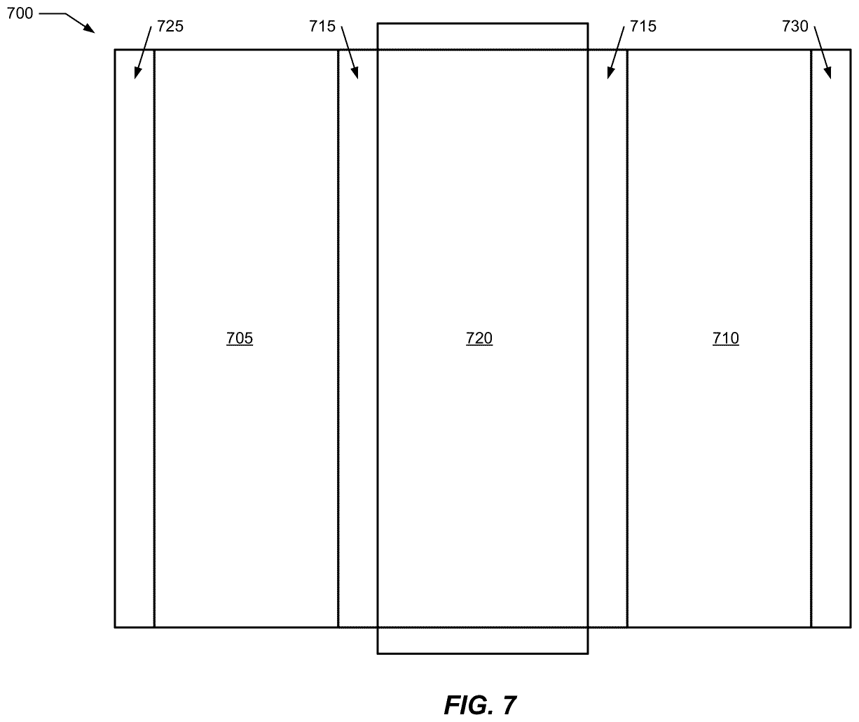

FIG. 7 illustrates a generic electrochemical cell 700. Cell 700 includes a first electrode 705 (e.g., a cathode electrode), a second electrode 710 (e.g., an anode electrode), a liquid electrolyte 715, a separator 720, a first current collector 725, and a second current collector 730. One or both electrodes include a coordination compound, and more specifically a transition metal cyanide coordination compound.

### REFERENCES

The following references are cited herein, and each of which is hereby expressly incorporated by reference thereto in its entirety for all purposes:
REF [1]—Kohn, M. (1943). Demonstration of some properties of Prussian blue. Journal of Chemical Education, 20 (4), 198; and
REF [2]—Zamponi, S., Kijak, A. M., Sommer, A. J., Marassi, R., Kulesza, P. J., & Cox, J. A. (2002). Electrochemistry of Prussian Blue in silica sol-gel electrolytes doped with polyamidoamine dendrimers. Journal of Solid State Electrochemistry, 6, 528-533.

The system and methods above have been described in general terms as an aid to understanding details of preferred embodiments of the present invention. In the description herein. numerous specific details are provided, such as examples of components and/or methods, to provide a thorough understanding of embodiments of the present invention. Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention is not limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

1. An electrochemical device, comprising:
an electrically-conductive structure including a TMCCC represented by Formula I:
Na_{b1}K_{b2}[R(CN)₆]_{c}
vacᵣ n(H₂O) FORMULA I;
wherein R(CN)₆ includes a coordination complex selected from the group consisting of hexacyanoferrate, hexacyanocobaltate, hexacyanochromate, and hexacyanomanganate;
wherein vac identifies an R(CN)₆ vacancy;
wherein 0<b1≤2 0 and 0<b2≤2;
wherein b1+b2≤2;
wherein for each element of the set {a4, a5}, 0<{a4, a5}≤1;
wherein 0<c≤1;
wherein 0≤r≤0.25;
wherein c+r=1; and
wherein n>0.

2. The electrochemical device of claim 1 further comprising a TMCCC positive electrode including said electrically-conductive structure; and further comprising a negative electrode.

3. The electrochemical device of claim 1 wherein Feₐ₅ includes Fe(II)_{d1} and Fe(III)_{d2}, wherein d1+d2=a5, wherein 0<d1≤1; and wherein 0<d2≤1.

4-30. (canceled)

31. The electrochemical device of claim 1 wherein Feₐ₅ includes Fe(II)_{d1} and Fe(III)_{d2}, wherein d1+d2=a5; and wherein a5>0.

32-33. (canceled)
